(19) United States
(12) Patent Application Publication
(10) Pub. No.: US 2021/0237674 A1
(43) Pub. Date: Aug. 5, 2021

(54) COMPACT KNEE AIRBAG

(71) Applicant: Byton North Amer1ca Corporation, Santa Clara, CA (US)

(72) Inventors: David TWOHIG, Los Gatos, CA (US); John SCHEICK, Mountain View, CA (US)

(21) Appl. No.: 16/782,017

(22) Filed: Feb. 4, 2020

(51) Int. Cl. B60R 21/203; B60R 21/233; B60R 21/261; B60R 21/2338; B60R 21/237; B60R 21/217

(52) U.S. Cl. CPC B60R 21/203; B60R 21/233; B60R 21/261; B60R 2021/23169; B60R 21/237; B60R 21/2176; B60R 21/2338

(57) ABSTRACT

Driver-side knee airbags, for vehicles, are described herein. One airbag has at least one cushion pack. Each cushion pack has an airbag cushion to be deployed. The airbag has an inflator. The inflator is outside of and coupled to the cushion pack, and is for inflating the airbag cushion. The cushion pack is dimensioned to be positioned below the steering column of the vehicle. Another airbag has a single cushion pack. The single cushion pack has a single airbag cushion to deploy. An inflator is inside the single airbag cushion. The single cushion pack is dimensioned to mount in a vertical orientation offset to one side of the steering column of the vehicle. In multiple versions of the airbag, an inflator is dimensioned to mount offset to one side of the steering column of the vehicle.

### FIELD OF THE INVENTION

The present invention relates to the field of vehicle airbags and, more specifically, driver-side knee airbags.

### BACKGROUND

Airbags in vehicles provide an energy absorbing airbag cushion that inflates during vehicle collision. Late-model vehicles have many airbags, each specialized for a specific location in the vehicle and direction or type of impact. Airbag types include frontal airbags, side airbags, side curtain airbags, side torso airbags, knee airbags for driver-side and front passenger, rear curtain airbags, seat cushion airbags, center airbags, seat belt airbags, and, recently, pedestrian airbags. Packaging constraints for airbags are generally an issue in vehicle and airbag design.

Some side curtain airbags have an airbag packed in a compact roll form. A tether to guide the airbag and to provide a reactionary restraint force is used in some side curtain airbags.

It is technically difficult to package a knee airbag (KAB), especially in lower vehicles with steeply-raked steering columns and low instrument panels. The physical distance between the steering column and the driver's legs may be insufficient for packaging a conventional airbag in a hard enclosure or case. Current vehicles use a conventional knee airbag with a cushion and an inflator, both of which are packed in a canister that is bulky to package integrated with the vehicle dashboard, and takes up a lot of space in the vertical dimension.

FIG. 1A is a side view of a prior art arrangement showing a vehicle steering column 104 and steering wheel 103, with a driver, showing clearance between the steering column 104 and the driver's legs 105. Because the instrument panel 101 is smaller, and there is more clearance between the steering column 104 and the legs 105, there is ample room for a standard prior art packaging of a driver-side knee airbag.

### SUMMARY

A driver-side knee airbag for a vehicle has at least one cushion pack, and an inflator. Each cushion pack has an airbag cushion to be deployed. The inflator is outside of the cushion pack or packs and is coupled to the cushion pack or packs. The inflator is for inflating the airbag cushion or cushions. The cushion pack, or packs, is dimensioned to be positioned below a steering column of the vehicle.

A vehicle with a driver-side knee airbag has a steering column. There is at least one cushion pack. The cushion pack, or packs, has an airbag cushion to be deployed. An inflator is outside of and coupled to the cushion pack or packs. The inflator is to inflate the airbag cushion or cushions. The cushion pack, or packs, is positioned below the steering column of the vehicle.

A driver-side knee airbag for a vehicle has a single cushion pack and an inflator. The single cushion pack has a single airbag cushion to deploy. The inflator is inside the single airbag cushion. The single cushion pack, with the inflator, is dimensioned to mount in a vertical orientation offset to one side of a steering column of a vehicle.

A driver-sized knee airbag for a vehicle has a cushion pack and an inflator. The cushion pack has an airbag cushion to deploy. The inflator is to inflate the airbag cushion. The inflator is dimensioned to mount offset to one side of a steering column of a vehicle.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a side view of a prior art arrangement showing a vehicle steering column and steering wheel, with a driver in an upright seating position typical to a SUV, showing clearance between the steering column and the driver's legs.

FIG. 1B is a side view of a vehicle steering column with the occupant in a reclined seating position, typical to a sedan, and less clearance between the steering column and the driver's legs.

FIG. 1C is a perspective view of a driver-side knee airbag with an inflator body external to the airbag cushion, in accordance with an embodiment.

FIG. 1D is a perspective view of a vehicle interior and driver position for an SUV and a sedan, showing differences in available space for packaging an airbag and other vehicle equipment.

FIG. 2 is a perspective view of a further driver-side knee airbag with two separate airbag cushions, each to be inflated by its own inflator, in accordance with an embodiment.

FIG. 3 is a perspective view of a further driver-side knee airbag with two separate airbag cushions to be inflated by a shared inflator connected with a Y diffuser, in accordance with an embodiment.

FIG. 4 is a perspective view of a further driver-side knee airbag with a single airbag cushion and an inflator inside of the airbag cushion, in accordance with an embodiment.

FIG. 5A is a side view of an airbag with an external inflator and roll packaging, as suitable for various embodiments.

FIG. 5B is a perspective view of an airbag with horizontal orientation and vertical or lateral deployment, as suitable for various embodiments.

FIG. 5C is a perspective view of an airbag with an internal tether, horizontal orientation and horizontal, longitudinal, or alternative lateral deployment, as suitable for various embodiments.

FIG. 5D is a perspective view of an airbag with lateral and vertical deployment, as suitable for various embodiments.

### DETAILED DESCRIPTION

A compact knee airbag design disclosed in various embodiments allows packaging of a driver-side knee airbag in a very restricted vertical space below and/or offset to one or both sides of a steering column in a vehicle.

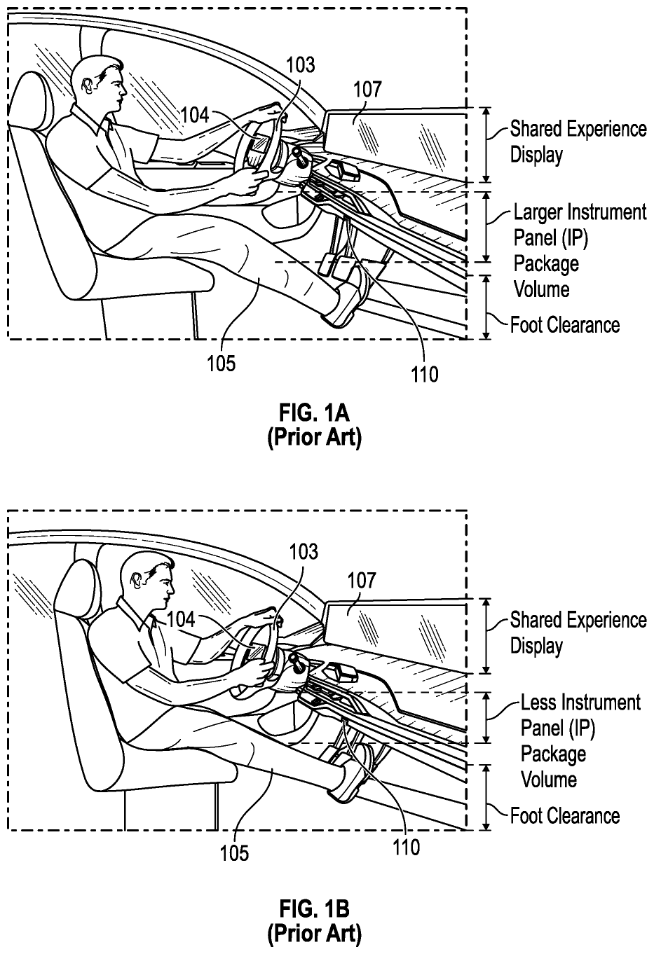

An airbag inflator or inflators offset on either side of the steering column deploys an airbag to protect the driver's knees. In some embodiments, the deployment direction is controlled by a tether system forcing the airbag into the space between the driver's legs and the steering column by gas pressure. The packaging space required immediately below the steering column is significantly reduced compared to existing designs. By shifting the inflator outside of the canister in some embodiments (e.g., FIGS. 1C-3), the canister can be reduced in size. In some embodiments, the canister is soft, not a hard enclosure or case.

Most embodiments have a pyrotechnic inflator positioned to one side of the steering column. Some embodiments of driver-side knee airbags have an airbag packaged in a compact roll form. Some embodiments have a tether on one side of the steering column to guide the airbag and provide the reactionary restraint force, thereby protecting the driver's legs.

The package of the inflator is shifted outside of the cushion canister in embodiments depicted in FIGS. 1C-3 and 5D, allowing for a smaller package. The inflator could be packaged immediately next to the cushion or connected by a tube, e.g., a tube of low or non-porous airbag cushion. The placement of the inflator to one or both sides of the steering column significantly reduces package space between the steering column and the driver's legs, allowing vehicles to have steeply raked steering columns, and is suitable for lower sedans and sports cars with low roof and hood heights. It should be appreciated that various embodiments of airbags described herein, and variations thereof, may be used in various types of vehicles such as electric vehicles, hybrid vehicles, plug-in electric hybrid vehicles, internal combustion powered vehicles, trucks, SUVs, automobiles, vans, buses, etc.

FIG. 1B is a side view of a vehicle steering column 104 with a lower instrument panel 107 and less clearance between the steering column 104 and the driver's legs 105. The decreased clearance between steering column 104 and legs 105, in comparison to the clearance shown in FIG. 1A provides a location for an improved driver-side knee airbag 110.

FIG. 1C is a perspective view of a driver-side knee airbag 110 with an inflator body 102 external to the airbag cushion, in accordance with an embodiment. The inflator nozzle is inserted into the cushion pack. A single airbag cushion, or in a variation two or more airbag cushions, is packed inside of the cushion pack 106, also called a knee airbag or KAB cushion pack. The cushion pack 106 with attached inflator 102 is dimensioned to mount, and mounted or positioned in a horizontal orientation below the steering column 104, at a lower panel 108 of the instrument panel of a vehicle. The longitudinal axis of the cushion pack 106 is parallel to the lower panel 108, and below and extending to both sides of the steering column 104, while the inflator 102 is offset to one side of (e.g., left or right) and below the steering column 104. This embodiment of a knee airbag with the inflator external to the airbag cushion allows fora smaller canister to package under a steering column.

FIG. 1D is a perspective view of a vehicle interior and driver position for an SUV and a sedan, showing differences in available space for packaging an airbag and other vehicle equipment. Dashed line 120 shows vehicle and driver position for a sedan, which can be compared with solid line 130 showing vehicle and driver position for an SUV. As the Hpoint drops, for the sedan, the eye ellipse also drops taking along sightlines with it. This forces the stage and steering column down to preserve the legal downward visibility. In combination with the needed foot clearance around the pedals, the end effect is a squished instrument panel (IP) and reduced space in the sedan for packaging the knee airbag and other vehicle equipment.

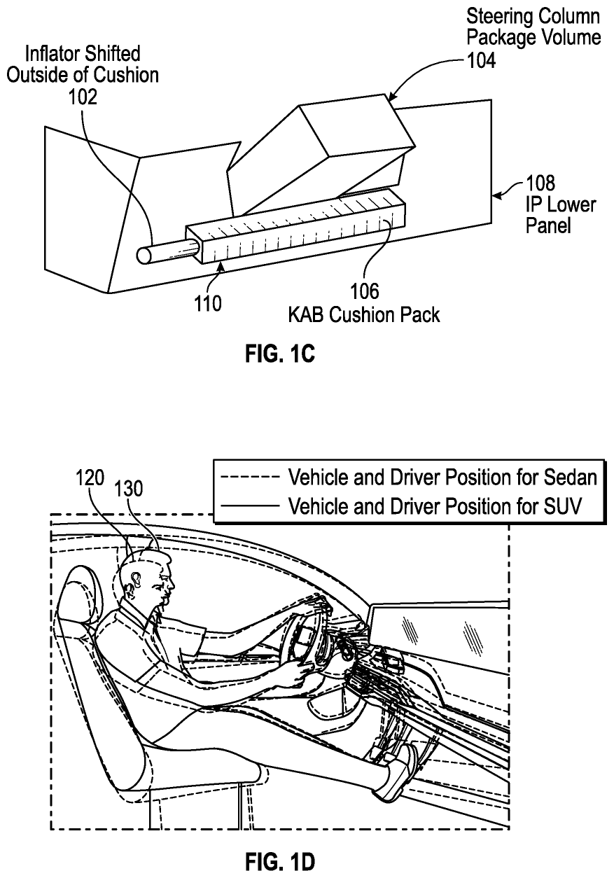

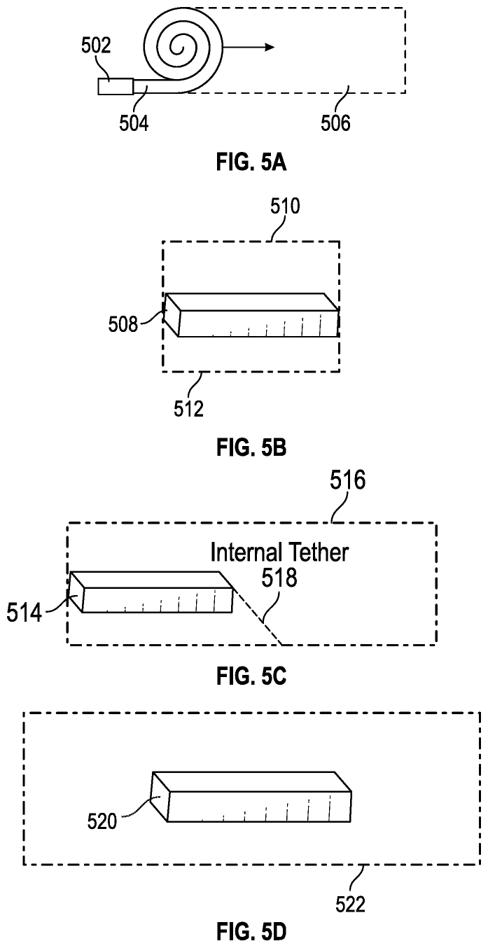

FIG. 2 is a perspective view of a further driver-side knee airbag 212 with two separate airbag cushions, each to be inflated by its own inflator 202, 204, in accordance with an embodiment. One airbag cushion is in a cushion pack 206 below and offset to the left of the steering column 104, another airbag cushion is in a cushion pack 208 below and offset to the right of the steering column 104. The inflator body 202 for the airbag cushion in the cushion pack 206 is external to the airbag cushion and the cushion pack 206, and extends to the left of the cushion pack 206. In mirror image fashion, the inflator 204 for the airbag cushion in the cushion pack 208 is external to the airbag cushion and the cushion pack 208, and extends to the right of the cushion pack 208. The inflator nozzles are inserted into the cushion pack. For the embodiment shown, both inflators 202, 204 are below the steering column 104, but variations are possible in which the cushion packs 206, 208 are mounted on a diagonal and the inflators 202, 204 are alongside of the steering column 104 (e.g., to the left and right of the steering column 104). Coverage for each knee comes from a separate cushion inflated by its own inflator. One version of the knee airbag features two inflators 202, 204 placed on either side of the steering column 104, deploying two airbags in a roll shape (e.g., see FIG. 5D) on either side of the steering column. Various types of airbag folding patterns, such as a Z fold, are used in further embodiments.

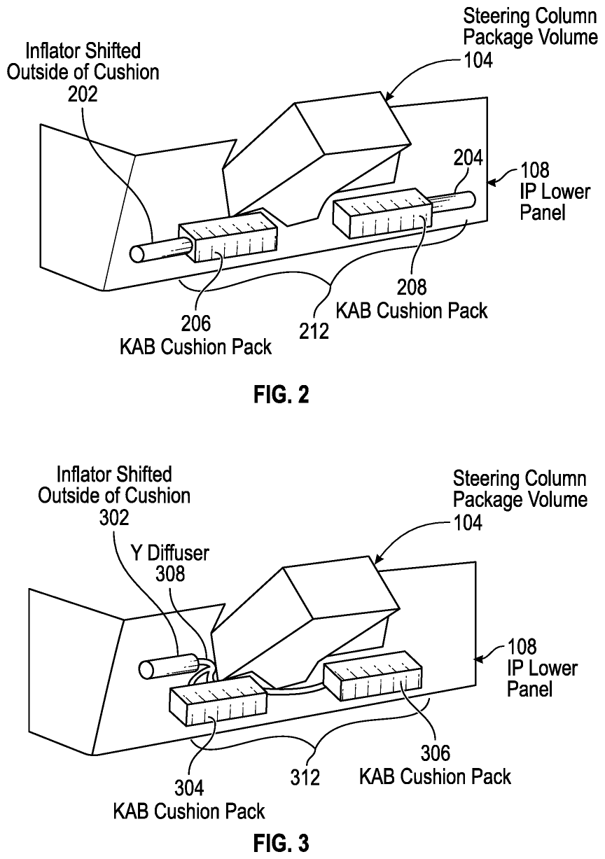

FIG. 3 is a perspective view of a further driver-side knee airbag 312 with two separate airbag cushions to be inflated by a shared inflator 302 connected with a Y diffuser 308, in accordance with an embodiment. One airbag cushion is in a cushion pack 304 below and offset to the left of the steering column 104, another airbag cushion is in a cushion pack 208 below and offset to the right of the steering column 104. The inflator both body and nozzle 302 for both airbags is external to the airbag cushions, external to the cushion packs 304, 306, and mounted to one side (e.g., left as shown, or alternatively right) of the steering column 104. The Y diffuser 308 is connected to both the inflator 302 and the airbags in the cushion packs 304, 306, with appropriate routing relative to the steering column 104 as readily devised. That is, the Y diffuser 308 couples the inflator 302 to both of the cushion packs 304, 306. For example, one arm of the Y diffuser 308 could route below the steering column 104 as shown in FIG. 3, or up and over the steering column 104, etc. Coverage for each knee comes from a separate cushion inflated by a shared inflator 302 connected with the Y diffuser 308.

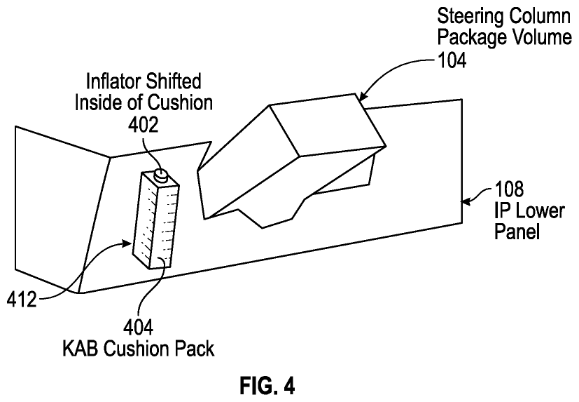

FIG. 4 is a perspective view of a further driver-side knee airbag 412 with a single airbag cushion and an inflator 402 inside of the airbag cushion, in accordance with an embodiment. The airbag cushion with internal inflator 402 is packed inside of a cushion pack 404. A vertical orientation of the knee airbag is packaged completely on the side of the steering column 104. That is, the airbag is positioned offset to the left of or to the right of the steering column 104, although not necessarily attached directly to the steering column 104, although it could be in some embodiments. The airbag deploys from side to side (e.g., left to right in FIG. 4. or right to left in an alternative version), instead of upwards or downwards. Some embodiments have an external tether, and some embodiments have an internal tether, to guide deployment of the airbag.

FIG. 5A is a side view of an airbag with an external inflator and roll packaging, as suitable for various embodiments. An inflator 502, in this version external to the airbag 504, but could be internal in other versions, expands the airbag 504, which unrolls and deploys in the direction shown in the arrow, to the deployed airbag shape 506 (shown in dashed outline). With various fabric shapes, various orientations, and possibly one or more tethers, the airbag can be made to deploy to the right, left, upwards or downwards or even on a diagonal for various embodiments. Other deployed shapes are readily devised.

FIG. 5B is a perspective view of an airbag with horizontal orientation and vertical or lateral deployment, as suitable for various embodiments. The airbag is expanded from the cushion pack 508 upwards to the deployed airbag shape 510 (shown in dashed outline), or downwards to the deployed airbag shape 512 (dashed outline), or both upwards and downwards to deployed airbag shape 510, 512 in various embodiments. Expansion and deployment of the airbag are considered vertical in the sense of relating to the orientation of the vehicle and driver, or are considered lateral in the sense of relating to the narrower width (versus length) of the cushion pack 508.

FIG. 5C is a perspective view of an airbag with an internal tether 518, horizontal orientation and horizontal, longitudinal, or alternative lateral deployment, as suitable for various embodiments. The airbag is expanded from the cushion pack 514 outwards and to one side, to the deployed airbag shape 516 (shown in dashed outline). Expansion and deployment oldie airbag are considered horizontal in the sense of relating to the orientation of the vehicle and driver, longitudinal in the sense of relating to the longitudinal axis of the cushion pack 514, or lateral in the sense of relating again to the orientation of the vehicle and driver.

Various arrangements and materials can be used for the tether 518, as readily devised. For example, the tether could be internal to the airbag, external to the airbag and attached to the cushion pack 514 or a portion of the lower panel 108 or steering column 104. The tether could be made of string, thread, cloth, plastic, rubber, elastic, etc.

FIG. 5D is a perspective view of an airbag with symmetric deployment, as suitable for various embodiments. The airbag is packed in a cushion pack 514 and expanded outwards symmetrically to the deployed airbag shape 522. Alternatively, an airbag could deploy to an asymmetric airbag shape as readily devised.

Features of embodiments shown and described with reference to FIGS. 5A-5D can be combined in various ways. For example, a tether (internal or external) and/or roll packaging can be used with upwards, downwards, to the side, symmetric or asymmetric deployment and deployed airbag shapes in various embodiments. One embodiment of the driver-side knee airbag shown in FIGS. 2 and 3 has airbags each with roll packaging and a tether. The airbags deploy towards each other and towards the underside of the steering column. One embodiment of the driver-side knee airbag shown in FIG. 4 has roll packaging and a tether, and the airbag deploys across the underside of the steering column.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein. It should be appreciated that descriptions of direction and orientation are for convenience of interpretation, and the apparatus is not limited as to orientation with respect to gravity. In other words, the apparatus could be mounted upside down, right side up, diagonally, vertically, horizontally, etc., and the descriptions of direction and orientation are relative to portions of the apparatus itself, and not absolute.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A driver-side knee airbag for a vehicle, comprising:
at least one cushion pack, each having an airbag cushion to be deployed;
an inflator, outside of and coupled to the at least one cushion pack, for inflating the each airbag cushion; and
the at least one cushion pack dimensioned to be positioned below a steering column of the vehicle.

2. The driver-side knee airbag for a vehicle of claim 1, wherein:
the at least one cushion pack comprises a single cushion pack;
the each having an airbag cushion to be deployed; and
the inflator comprises a single inflator to inflate the single airbag cushion of the single cushion pack.

3. The driver-side knee airbag for a vehicle of claim 1, wherein:
the inflator comprises a first inflator body outside of the first airbag cushion with the inflator nozzle inserted into the cushion to inflate the first airbag cushion

4. The driver-side knee airbag fora vehicle of claim 1, wherein:
the at least one cushion pack comprises a first cushion pack and a second cushion pack;
the each having an airbag cushion to be deployed comprises a first airbag cushion in the first cushion pack, and a second airbag cushion in the second cushion pack; and
the inflator comprises a single, shared inflator and a Y diffuser.

5. The driver-side knee airbag for a vehicle of claim 1, further comprising:
the airbag cushion having an internal tether.

6. The driver-side knee airbag for a vehicle of claim 1, further comprising:
the airbag cushion having roll packaging or Z fold packaging.

7. The driver-side knee airbag for a vehicle of claim 1, wherein the at least one cushion pack is not a hard enclosure nor a hard case.

8. A vehicle with a driver-side knee airbag, comprising:
a vehicle, having a steering column;
at least one cushion pack, having an airbag cushion to be deployed;
an inflator, outside of and coupled to the at least one cushion pack, to inflate the airbag cushion; and
the at least one cushion pack positioned below the steering column of the vehicle.

9. The vehicle with a driver-side knee airbag of claim 8, wherein:
the at least one cushion pack positioned below the steering column of the vehicle comprises a single cushion pack positioned in a horizontal orientation below the steering column, at a lower panel of an instrument panel;
the at least one cushion pack having an airbag cushion to be deployed comprises a single airbag cushion packaged in the single cushion pack; and
the inflator comprises a single inflator below and offset to one side of the steering column, coupled to inflate the single airbag cushion.

10. The vehicle with a driver-side knee airbag of claim 8, wherein:
the at least one cushion pack positioned below the steering column of the vehicle comprises a first cushion pack positioned below and offset to a first side of the steering column and a second cushion pack positioned below and offset to a second side of the steering column;
the at least one cushion pack having an airbag cushion comprises a first airbag cushion in the first cushion pack, and a second airbag cushion in the second cushion pack; and
the inflator comprises a first inflator body outside of the first airbag cushion with the nozzle inserted into the cushion to inflate the first airbag cushion and a second inflator body outside of the second airbag cushion with the nozzle inserted into the cushion to inflate the second airbag cushion.

11. The vehicle with a driver-side knee airbag of claim 8, wherein:
the at least one cushion pack positioned below the steering column of the vehicle comprises a first cushion pack positioned below and offset to a first side of the steering column and a second cushion pack positioned below and offset to a second side of the steering column;
the at least one cushion pack having an airbag cushion comprises a first airbag cushion in the first cushion pack, and a second airbag cushion in the second cushion pack; and
the inflator comprises a single, shared inflator and a Y diffuser coupled to the inflator, the first airbag cushion and the second airbag cushion.

12. The vehicle with a driver-side knee airbag of claim 8, further comprising:
at least one internal airbag tether.

13. The vehicle with a driver-side knee airbag of claim 8, further comprising:
the airbag cushion having roll packaging.

14. The vehicle with a driver-side knee airbag of claim 8, wherein the at least one cushion pack does not include a hard enclosure nor a hard case.

15. A driver-side knee airbag for a vehicle, comprising:
a single cushion pack, having a single airbag cushion to deploy;
an inflator inside the single airbag cushion; and
the single cushion pack, with the inflator, dimensioned to mount in a vertical orientation offset to one side of a steering column of a vehicle.

16. The driver-side knee airbag for a vehicle of claim 15, further comprising:
the single airbag cushion having an internal tether.

17. The driver-side knee airbag for a vehicle of claim 15, further comprising:
the single airbag cushion having roll packaging.

18. The driver-side knee airbag for a vehicle of claim 15, wherein the single cushion pack is not a hard enclosure nor a hard case.

19. The driver-side knee airbag for a vehicle of claim 15, wherein the single airbag cushion is to deploy from the one side of the steering column, to below the steering column, and to an opposing side of the steering column.

20. The driver-side knee airbag for a vehicle of claim 15, wherein the single airbag cushion has roll packaging and an internal tether, and is to deploy across an underside of the steering column.

21. A driver-side knee airbag for a vehicle, comprising:
a cushion pack, having an airbag cushion to deploy;
an inflator to inflate the airbag cushion; and
the inflator dimensioned to mount offset to one side of a steering column of a vehicle.

22. The driver-side knee airbag for a vehicle of claim 21, further comprising:
the cushion pack dimensioned to mount below the steering column of the vehicle,
wherein the inflator is coupled to and external to the cushion pack.

23. The driver-side knee airbag for a vehicle of claim 21, further comprising:
the cushion pack dimensioned to mount below and offset to the one side of the steering column of the vehicle, wherein the inflator is coupled to and external to the cushion pack;
a further cushion pack, having a further airbag cushion to deploy, and dimensioned to mount below and offset to another side of the steering column of the vehicle; and
a further inflator, dimensioned to mount offset to another side of the steering column of the vehicle, wherein the inflator is coupled to and external to the further cushion pack.

24. The driver-side knee airbag for a vehicle of claim 21, further comprising:
the cushion pack dimensioned to mount below and offset to the one side of the steering column of the vehicle;
a further cushion pack, having a further airbag cushion to deploy, and dimensioned to mount below and offset to another side of the steering column of the vehicle; and
a Y diffuser that couples the inflator to the cushion pack and the further cushion pack.

25. The driver-side knee airbag for a vehicle of claim 21, further comprising:
the inflator inside the airbag cushion, the cushion pack dimensioned to mount in a vertical orientation offset to the one side of the steering column of the vehicle.
